(19) United States
(12) Patent Application Publication
(10) Pub. No.: US 2009/0196479 A1
(43) Pub. Date: Aug. 6, 2009

(54) METHOD AND APPARATUS FOR COMPUTER-AIDED DIAGNOSIS FILTERED PRIORITIZED WORK ITEM LIST

(76) Inventors: Raghav Raman, Cupertino, CA (US); Chris Beaulieu, Los Altos, CA (US); David Paik, Half Moon Bay, CA (US); Eric Feingold, Philadelphia, PA (US); Murali Kumaran Kariathungal, Hoffman Estates, IL (US); Vijaykalyan Yeluri, Sunnyvale, CA (US); Denny Lau, Emeryville, CA (US)

Correspondence Address: MCANDREWS HELD & MALLOY, LTD, 500 WEST MADISON STREET, SUITE 3400, CHICAGO, IL, 60661, US

(21) Appl. No.: 12/023,644

(22) Filed: Jan. 31, 2008

(51) Int. Cl. G06K 9/00

(52) U.S. Cl. 382/132

(57) ABSTRACT

Certain embodiments of the present invention provide a system and method for prioritizing medical imaging scans. An image acquisition device, such as a computerized tomography (CT) system, an ultrasound system, an electron beam tomography (EBT) system, a magnetic resonance (MR) system and the like, generates medical imaging scans. A computer aided diagnosis application manager may be used to select a computer aided diagnosis application based on information associated with an imaging scan. The imaging scan may be examined with the computer aided diagnosis application. If the examination of the imaging scan indicates the imaging scan contains urgent findings, the imaging scan may be identified as priority. The indication of the imaging scan as priority may be communicated to a physician so the physician may review the priority imaging scan before non-priority imaging scans.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a system and method for prioritizing radiology exams. Particularly, the present invention relates to using computer-aided diagnosis to detect image findings that are time sensitive and require attention.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

As medical imaging has become more routine in the practice of healthcare professionals, it is increasingly common for patients to have a medical imaging scan. It is also increasingly common for an individual patient to have multiple imaging scans. Accordingly, the modern practice of medicine is typically generating many imaging scans. As more imaging scans are generated, the length of time before a radiologist examines the imaging scans may increase. A backlog of imaging scans that have been acquired but that have not been examined may be created. The creation of a backlog of imaging scans may present a dangerous situation. Imaging scans that have urgent findings requiring immediate attention may not be immediately reviewed and valuable time may be lost.

Therefore, there is a need for a system and method which can prioritize imaging scans for review by a radiologist. Such a system and method may prioritize imaging scans based on the urgency of the findings in the medical images.

### SUMMARY OF THE INVENTION

Certain embodiments of the present invention provide a system and method for prioritizing medical imaging scans. The method comprises acquiring a first image set of medical images. A computer aided diagnosis application is selected based on information associated with the first image set. In an embodiment, the information associated with the first image set includes information regarding the anatomy illustrated in the first image set. In an embodiment, the information associated with the first image set includes information regarding the technique used to acquire the first image set. In an embodiment, the computer aided diagnosis application is selected based on header information for the first image set. The method also includes examining the first image set with the computer aided diagnosis application. The method also includes identifying the first image set as priority if the examination of the first image set by the computer aided diagnosis application indicates the first image set contains urgent findings. The method may also include notifying a user that the first image set has been identified as priority. Notifying the user that the first image set has been identified as priority may include updating the work list of a physician. In an embodiment, the first image may be identified as non-priority if the examination of the first image set by the computer aided diagnosis application indicates the first image set does not contain urgent findings.

Certain embodiments of the present invention may include a computer-readable storage medium including a set of instructions for a computer. The set of instructions may include an acquisition routine for acquiring a first image set of medical images. The set of instructions may also include a selection routine for selecting a computer aided diagnosis application based on information associated with the first image set. In an embodiment, the information associated with the first image set includes information regarding the anatomy illustrated in the first image set. In an embodiment, the information associated with the first image set includes information regarding the technique used to acquire the first image set. In an embodiment, the computer aided diagnosis application is selected based on header information for the first image set. The set of instructions may also include an examination routine for examining the first image set with the computer aided diagnosis application. The set of instructions may also include an identification routine for identifying the first image set as priority if the examination of the first image set by the computer aided diagnosis application indicates the first image set contains urgent findings. The set of instructions may also include notifying a user that the first image set has been identified as priority. Notifying the user that the first image set has been identified as priority may include updating the work list of a physician. In an embodiment, the first image may be identified as non-priority if the examination of the first image set by the computer aided diagnosis application indicates the first image set does not contain urgent findings.

Certain embodiments of the present invention may also include a system for prioritizing medical imaging scans. The system may include a user interface unit for communicating with a user. The system may also include an image acquisition unit for acquiring medical imaging data. The system may also include a computer aided diagnosis unit for executing computer software, the computer software selecting a computer aided diagnosis application based on information associated with the medical imaging data, the computer aided diagnosis application processing the medical imaging data to identify urgent findings. The system may further include a control unit for controlling operations between the computer aided diagnosis unit and the image acquisition unit. The system may further include a server unit for storing, processing, or operating on the medical imaging data. In an embodiment, the control unit and the computer aided diagnosis unit operate as part of the server unit. In an embodiment, the server unit is a picture archive communication system. In an embodiment, the computer aided diagnosis application may include lung computer aided diagnosis, colon computer aided diagnosis, or mammography computer aided diagnosis.

### BRIEF DESCRIPTION OF THE DRAWINGS

FIG. 1 illustrates a system for prioritizing imaging scans in accordance with an embodiment of the present invention.

FIG. 2 illustrates a work flow that may be used in accordance with an embodiment of the present invention.

FIG. 3 illustrates a method in accordance with an embodiment of the present invention.

### DETAILED DESCRIPTION OF THE INVENTION

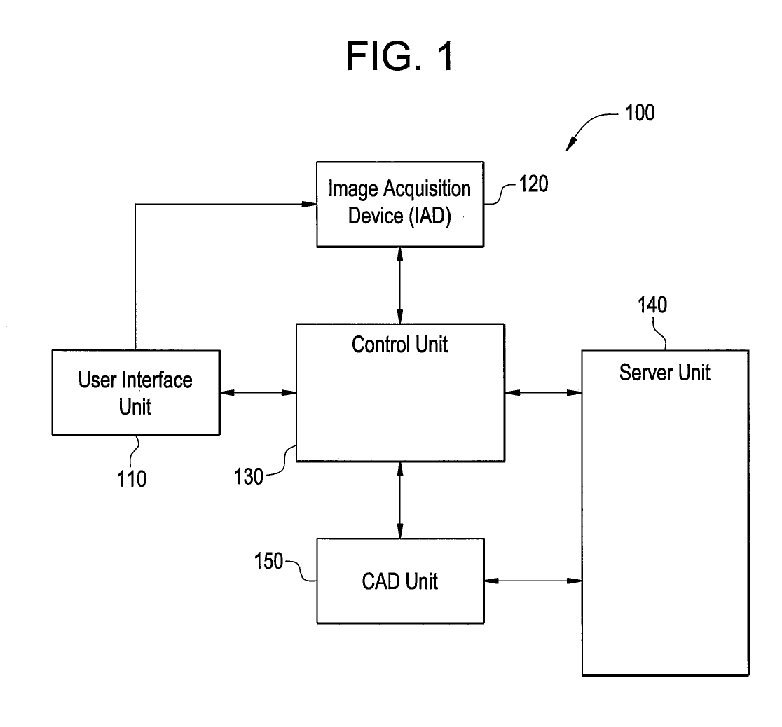

FIG. 1 illustrates a system 100 for prioritizing imaging scans in accordance with an embodiment of the present invention. The system 100 includes a user interface unit 110 for communicating with a user. The user interface unit 110 may acquire and/or process user commands as well as present information to a user. The user interface unit 110 is in electrical communication with the control unit 130 and image acquisition device 120 (“IAD 120”). The control unit 130 controls operations of the system 100. The control unit 130 is in electrical communication with the IAD 120, a CAD unit 150, and a server unit 140. The IAD 120 acquires and generates images and/or image data for processing. The computer-aided diagnosis (“CAD”) unit 150 executes CAD software to process image sets. The CAD software may be used to detect image sets that should be given priority for review. The server unit 140 stores, processes, and/or operates on images generated by the IAD 120 and/or other data available to the system 100. The components of the system 100 may be single units, separate units, may be integrated in various forms, and may be implemented in hardware and/or in software.

The user interface unit 110 may be used for communicating with a user. The communication may include acquiring and/or processing commands from a user as well as presenting information to a user. In an embodiment, the user interface unit 110 may be a computing device with one or more devices to acquire commands from a user, and one or more devices to present information to a user. For example, the computing device may be a typical personal computer, notebook computer, personal digital assistant, or other computer unit. Typical devices used to acquire commands from a user may be a computer mouse, a computer keyboard, and/or microphone. Typical devices used to present information to a user may be a display unit or speakers.

The control unit 130 generally controls operations in the system 100. Such operations include data processing and communications. The control unit 130 receives user commands from the user interface unit 110 and coordinates operations of the IAD 120, the CAD unit 150, and the server unit 140. The control unit 130 may also receive image sets from the IAD 120. The control unit 130 may perform operations and/or present the image set to a user through the user interface 110. The control unit 130 may also communicate the image set to the server 140 unit for storage and/or processing.

The IAD 120 acquires and processes images and image sets. The images may be two or three-dimensional, and are generally images of the type generated by any medical diagnostic imaging device, including x-ray devices, computerized tomography (CT) devices, ultrasound devices, electron beam tomography (EBT) devices, magnetic resonance (MR) devices, and the like. The images and image sets may be communicated to the control unit 130 for processing and distribution.

The CAD unit 150 executes CAD application software. The CAD application software may process the image sets acquired by the IAD 120. A suite of CAD applications may be used to detect image set findings that require prioritized attention. For example, findings that a CAD application may identify as priority are misplaced line inside a patient's body or a brain hemorrhage. In an embodiment, a distinct CAD application may be used to detect different findings. For example, certain CAD applications would be suitable for certain image sets. Which CAD applications are suitable for which image sets may be determined based on the technique of acquisition of the image set and the anatomy of the image set. The CAD application software may include a CAD application manager that could determine which CAD applications within a suite of CAD applications may be used to process the image set.

In an embodiment, if the CAD application detects a possible finding in the exam that should get prioritized attention, the image set may be flagged as urgent in the radiologist's work items list. The radiologist's work items list may be displayed on the user interface 110. If the CAD application does not detect any findings that are urgent in the image set, the image set is ordered in the radiologist's work items list in the order it was received.

The server unit 140 generally stores, processes, and/or operates on the data available to the system 100. Image sets acquired by the IAD 120 may be communicated to the control unit 130. The control unit 130 may communicate the image sets and associated image information to the server unit 140 for processing or storage. The control unit 130 may also retrieve data stored on the server unit 140 for processing, or may instruct the server unit 140 to process data. The control unit 130 may also be in communication with the CAD unit 150. The control unit 130 may send an image set to the CAD unit 150 for processing by the CAD software. In an embodiment, the system 100 may be, or may include, a picture archive communication system (PACS). Typically a PACS system is used for archiving images, as well as distributing and displaying images. PACS systems are commonly used in radiology departments to support image management. Several PACS systems are currently available, including PACS systems manufactured by General Electric Medical Systems, Siemens, Agfa, Fuji, and Philips.

In operation, a user may instruct the IAD 120 to perform a first image set acquisition. The first image set acquisition may be of a patient, for example Patient A. The user manipulates the user interface unit 110 to issue a command to the IAD 120 to perform an image set acquisition. The IAD 120 then generates the first image set by performing the first acquisition. The IAD 120 may then communicate the first image set to the control unit 130. The control unit 130 may process the first image set and communicate with the user interface unit 110 to present the first image set to a user. In an embodiment, the images may be displayed to a user on a display unit as part of the user interface unit 110. The user may interpret and/or manipulate the images using the user interface unit 110.

In an embodiment, the control unit 130 may process the first image set and communicate with the server unit 140 and CAD unit 150. The control unit 130 may send the first image set to the server unit 140 for storage and processing. The control unit 130 may send the first image set to the CAD unit for processing by the CAD software. The CAD software may include a CAD application manager. The CAD application manager may determine the technique of acquisition of the first image set and the anatomy imaged in the first image set. In an embodiment, the CAD application manager may determine the technique and anatomy based on identifier tags that are part of the first image set. The CAD application manager may then select a CAD application to process the first image set. The selected CAD application would search for indicators that the patient required urgent care. For example, the CAD application may search for a specific type of finding such as lung CAD, colon CAD, or mammography CAD. The CAD application may search for other abnormalities in the image set that may indicate the patient requires urgent care.

After the CAD unit 150 executes the appropriate CAD application, the CAD unit 150 may communicate with the control unit 130. If the CAD, application locates an urgent finding, the image set is tagged as priority. The control unit 130 may communicate with the user interface 110 and update the work items list for the radiologist identifying the first image set as priority for review. If the CAD application does not locate any findings that may be considered urgent, the image set is tagged as non-priority. The control unit 130 may communicate with the user interface 110 and update the work items list for the radiologist. The communication may identify the first image set as non-priority for review. At the time when the radiologist desires to review the first image set, the user interface 110 may communicate with the control unit 130. The control unit 130 may retrieve the first image set from the server unit 140 and send the first image set to the user interface 110. The retrieval may be local or over a network.

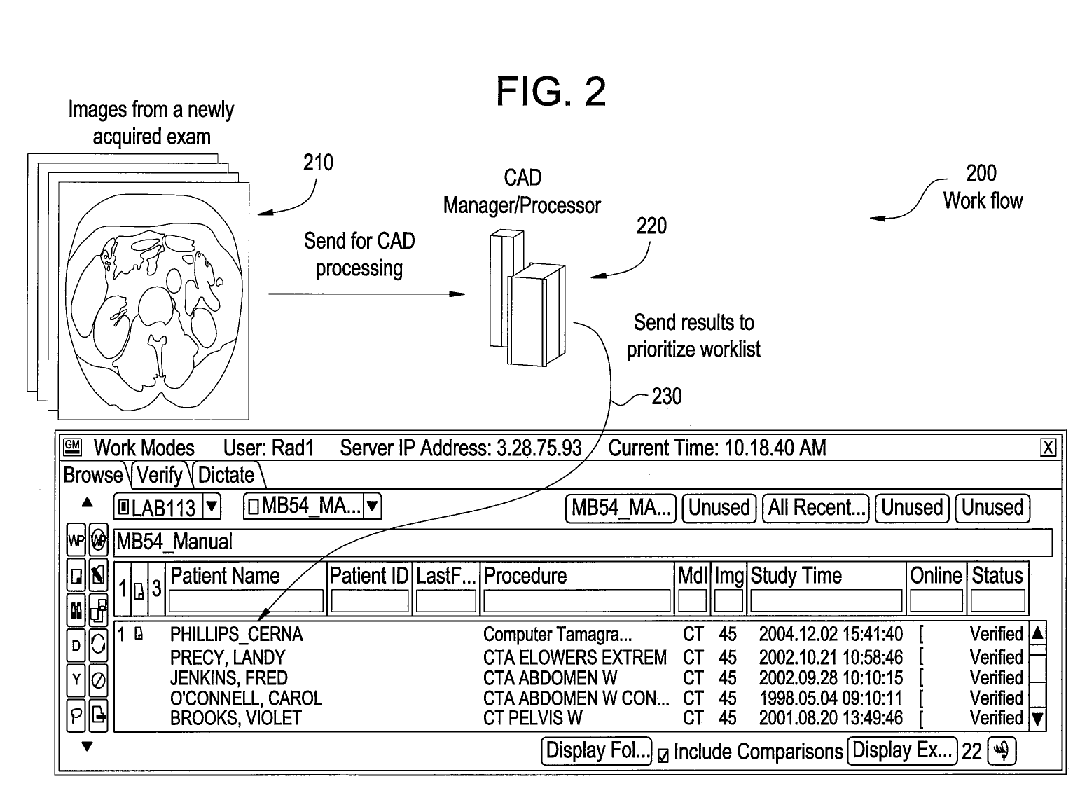

FIG. 2 illustrates a work flow 200 that may be used in accordance with an embodiment of the present invention. The work flow 200 illustrates an embodiment of the system 100 in which the control unit 130 and the CAD unit 150 operate internal to the server unit 140. In an embodiment, the server unit 220 is a picture archive communication system (PACS server). The PACS server may communicate/operate on data acquired by the IAD 120. The PACS server may also receive data from and send data to the user interface unit 110. FIG. 2 also illustrates an example of a first set of images 210. The user interface unit 110 and the IAD 120 are not shown in FIG. 2.

Once the first set of images 210 is acquired, the images 210 may be transmitted to the server unit 220. The server unit 220 may operate CAD application management and application software. In an embodiment, the CAD application manager on the server unit 220 may receive the first set of images 210. The CAD application manager searches the information associated with the first set of images 210 for information regarding the technique used to acquire the first set of images 210 and the anatomy the first set of images 210 has captured. For example, the information regarding the technique may include information about whether the first set of images were captured using x-ray systems, computerized tomography (CT) systems, ultrasound systems, electron beam tomography (EBT) systems, magnetic resonance (MR) systems or other type of system. The information regarding anatomy may include information regarding whether the images are of lungs, colon, or mammography images. The CAD application manager can determine which CAD application should be used to process the first image set 210 based on the technique and anatomy. Examples of CAD applications that may be selected by the CAD application manager may include lung CAD, colon CAD, or mammography CAD.

Once the CAD application has been selected, the server unit 220 processes the first image set 210 with the selected CAD application. The CAD application searches for abnormalities in the images to determine if the patient requires urgent care. For example, the CAD application may search for abnormal structures or lines in a given anatomy. Once the CAD application has processed the first image set 210, the results of the processing may be encoded according to the Digital Imaging and Communications in Medicine (DICOM) standard. The server unit 220 may store the information regarding execution of the CAD application, including which CAD application was executed and the results.

The server unit 220 may then send the results of the CAD application to a prioritized work list 230. The prioritized work list 230 may be, or may be included in, a software application for use by a user, for example a radiologist. In an embodiment, the prioritized work list 230 is running on a computer that is networked with the server unit 220. It is contemplated that the prioritized work list 230 is running on a personal digital assistant, such as a handheld unit or other device that is in wireless communication with the server unit 220. The prioritized work list 230 indicates to the radiologist the order the radiologist should review the image sets. If the CAD application determines that the first image set 210 requires urgent review, the first image set 210 is tagged as priority. The tagging as priority of the first image set 210 indicates to the radiologist that the first image set 210 may require urgent attention. If the CAD application determines that the first image set 210 does not require urgent review, then the first image set 210 is not tagged as priority. In an embodiment, however, the first image set 210 is tagged as having been reviewed by the CAD application. The non-priority first image set 210 may be used to update the prioritized work list 230. The non-priority first image set 210 is added to the prioritized work list 230, but the first image set 210 is not indicated as priority. In an embodiment, however, the first image set 210 may be indicated to have been reviewed by the CAD application. The indication that the first image set 210 was reviewed by CAD, but determined not to be priority, provides affirmative information to the radiologist that the first image set 210 was reviewed.

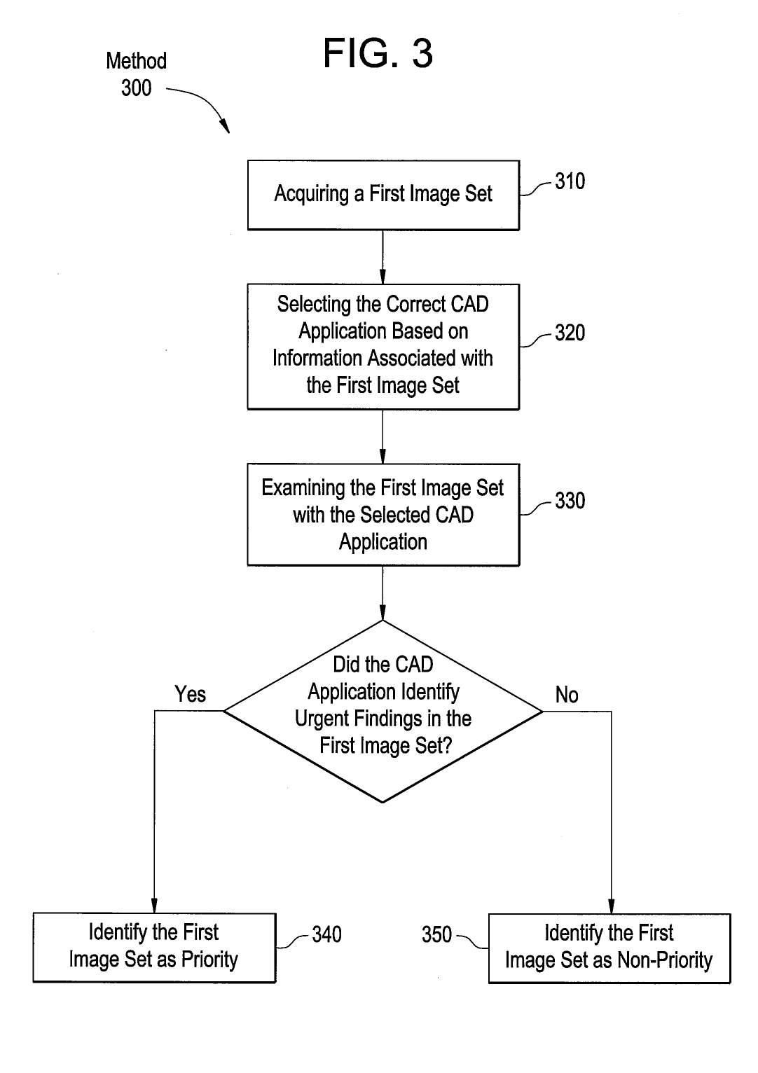

FIG. 3 illustrates a method 300 in accordance with an embodiment of the present invention. At step 310, a first image set is acquired. The first image set may be acquired using x-ray systems, computerized tomography (CT) systems, ultrasound systems, electron beam tomography (EBT) systems, magnetic resonance (MR) systems or other type of system. In an embodiment, the first image set may also be acquired from memory or other processor. In an embodiment, the type of acquisition technique is identified in header information for the first image set. The type of anatomy may also be identified in header information for the first image set. For example, the type of anatomy may include lungs, colon, brain, or other type of anatomy.

At step 320, the correct CAD application is selected. The CAD application is selected based on information associated with the first image set. In an embodiment, the CAD application is selected based on the header information from the first image set. The header information may include the technique used to acquire the first image set. The header information may also include the type of anatomy in the first image set. In an embodiment, based on this information, a CAD application is selected.

At step 330, the first image set is examined with the selected CAD application. In an embodiment, the first image set is examined for abnormalities. The examination for abnormalities may reveal an urgent need for care to the patient. In an embodiment, each of the available CAD applications is specifically designed to detect abnormalities for particular anatomies. For example, a lung CAD may detect abnormalities in the lungs, a colon CAD may detect abnormalities in the colon, a mammography CAD may detect abnormalities in the breast. If the CAD application identified urgent findings in the first image set, the method 300 executes step 340. If the CAD application does not identify urgent findings in the first image set, the method 300 executes step 350.

At step 340, the first image set has been identified as having urgent findings and is marked as being priority. The identification of the first image set as priority indicates to the radiologist that the patient from which the first image set originated may need urgent care. The radiologist may be notified of the priority mark of the first image set by updating the work list of the radiologist. The work list of the radiologist may be a software program running on a computer. In an embodiment, the work list may be a software program running on a hand held device, such as personal digital assistant. Upon notification of a priority image set, the radiologist may examine the priority image set prior to examining other image sets.

As step 350, the first image set has been identified as having non-urgent findings and is marked as non-priority. In an embodiment, the first image set is not marked when no urgent findings are found. Alternatively, the first image set is marked as having non-urgent findings. The mark having non-urgent findings indicates to the radiologist that the image set has been examined. The work list of the radiologist may be updated with the first image set and the first image set may be identified as non-priority. Upon notification of a non-priority image set, the radiologist may examine other image sets marked as priority before examining the non-priority image set.

The system and method described above may be carried out as part of a computer-readable storage medium including a set of instructions for a computer. The set of instructions may include an acquisition routine for acquiring a first image set. The acquisition routine may include acquiring the first image set from memory or from a processor. The set of instructions may include a selection routine for selecting the correct CAD application based on information associated with the first image set. In an embodiment, the CAD application is selected based on the header information from the first image set. The header information may include the technique used to acquire the first image set. The header information may also include the type of anatomy in the first image set. In an embodiment, based on this information, a CAD application is selected.

The set of instructions may include an examination routine for examining the first image set with the selected CAD application. In an embodiment, the first image set is examined for abnormalities. The examination for abnormalities may reveal an urgent need for care to the patient. In an embodiment, each of the available CAD applications is specifically designed to detect abnormalities for particular anatomies. For example, a lung CAD may detect abnormalities in the lungs, a colon CAD may detect abnormalities in the colon, a mammography CAD may detect abnormalities in the breast. If the CAD application identified urgent findings in the first image set, the set of instructions executes an identification of priority routine. If the CAD application does not identify urgent findings in the first image set, the set of instructions executes an identification of non-priority routine.

The identification of priority routine identifies the first image set as priority and indicates to the radiologist that the patient from which the first image set originated may need urgent care. The radiologist may be notified of the priority mark of the first image set by updating the work list of the radiologist. The work list of the radiologist may be a software program running on a computer. In an embodiment, the work list may be a software program running on a hand held device, such as personal digital assistant. Upon notification of a priority image set, the radiologist may examine the priority image set prior to examining other image sets.

The identification of non-priority routine identifies the first image set as non-priority and indicates to the radiologist that the patient from which the first image set originated does not need urgent care. In an embodiment, the first image set is not marked when no urgent findings are found. Alternatively, the first image set is marked as having non-urgent findings. The mark having non-urgent findings indicates to the radiologist that the image set has been examined. The work list of the radiologist may be updated with the first image set and the first image set may be identified as non-priority. Upon notification of a non-priority image set, the radiologist may examine other image sets marked as priority before examining the non-priority image set.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims

1. A method for prioritizing medical imaging scans, said method comprising:
acquiring a first image set of medical images;
selecting a computer aided diagnosis application based on information associated with said first image set;
examining the first image set with said computer aided diagnosis application;
identifying the first image set as priority if the examination of the first image set by the computer aided diagnosis application indicates the first image set contains urgent findings.

2. The method of claim 1, further comprising notifying a user that the first image set has been identified as priority.

3. The method of claim 2, wherein notifying said user that the first image set has been identified as priority includes updating the work list of a physician.

4. The method of claim 1, further comprising identifying the first image set as non-priority if the examination of the first image set by the computer aided diagnosis application indicates the first image set does not contain urgent findings.

5. The method of claim 1, wherein said information associated with said first image set includes information regarding the anatomy illustrated in the first image set.

6. The method of claim 1, wherein said information associated with said first image set includes information regarding the technique used to acquire the first image set.

7. The method of claim 1, wherein the computer aided diagnosis application is selected based on header information for the first image set.

8. A computer-readable storage medium including a set of instructions for a computer, the set of instructions comprising:
an acquisition routine for acquiring a first image set of medical images;
a selection routine for selecting a computer aided diagnosis application based on information associated with said first image set;
an examination routine for examining the first image set with said computer aided diagnosis application;
an identification routine for identifying the first image set as priority if the examination of the first image set by the computer aided diagnosis application indicates the first image set contains urgent findings.

9. The set of instructions of claim 8, further comprising notifying a user that the first image set has been identified as priority.

10. The set of instructions of claim 9, wherein notifying said user that the first image set has been identified as priority includes updating the work list of a physician.

11. The set of instructions of claim 8, further comprising identifying the first image set as non-priority if the examination of the first image set by the computer aided diagnosis application indicates the first image set does not contain urgent findings.

12. The set of instructions of claim 8, wherein said information associated with said first image set includes information regarding the anatomy illustrated in the first image set.

13. The set of instructions of claim 8, wherein said information associated with said first image set includes information regarding the technique used to acquire the first image set.

14. The set of instructions of claim 8, wherein the computer aided diagnosis application is selected based on header information for the first image set.

15. A system for prioritizing medical imaging scans, said system comprising:
a user interface unit for communicating with a user;
an image acquisition unit for acquiring medical imaging data; and,
a computer aided diagnosis unit for executing computer software, said computer software selecting a computer aided diagnosis application based on information associated with said medical imaging data, said computer aided diagnosis application processing said medical imaging data to identify urgent findings.

16. The system of claim 15, further comprising a control unit for controlling operations between said computer aided diagnosis unit and said image acquisition unit.

17. The system of claim 16, further comprising a server unit for storing, processing, or operating on said medical imaging data.

18. The system of claim 17, wherein said control unit and said computer aided diagnosis unit operate as part of said server unit.

19. The system of claim 17, wherein the server unit is a picture archive communication system.

20. The system of claim 15, wherein said computer aided diagnosis application includes lung computer aided diagnosis, colon computer aided diagnosis, or mammography computer aided diagnosis.
